(19) United States
(12) Patent Application Publication
(10) Pub. No.: US 2005/0064252 A1
(43) Pub. Date: Mar. 24, 2005

(54) Method for operating polymer electrolyte fuel cell

(76) Inventors: Hiroki Kusakabe, Osaka (JP); Kazuhito Hatoh, Osaka (JP); Hideo Ohara, Osaka (JP); Shinsuke Takeguchi, Osaka (JP); Soichi Shibata, Osaka (JP); Shinichi Arisaka, Osaka (JP); Yasuo Takebe, Uji-shi (JP)

Correspondence Address: MCDERMOTT, WILL & EMERY, 600 13th Street, N.W., Washington, DC, 20005-3096, US

(21) Appl. No.: 10/825,217

(22) Filed: Apr. 16, 2004

(30) Foreign Application Priority Data
Apr. 17, 2003 (JP) JP2003-112943

(51) Int. Cl. H01M 8/00

(52) U.S. Cl. 429/13; 429/12

(57) ABSTRACT

A method for easily, quickly and accurately detecting a cross leak or a micro short-circuit in a unit cell or group of cells of a fuel cell stack is provided by determining an electric output of the unit cell or group of cells after stoppage of fuel and/or oxidant and preferably during the introduction of a non-fuel and non-oxidant gas to the cell.

### BACKGROUND

The present invention relates to a method for operating a fuel cell for use in portable power sources, power sources for electric vehicles, home cogeneration systems, etc. More specifically, the present invention relates to a method for detecting a defective unit cell or a defective group of unit cells in a fuel cell comprising a stack of unit cells.

A polymer electrolyte fuel cell with a polymer electrolyte membrane generates electricity and heat simultaneously through an electrochemical reaction between a fuel gas such as hydrogen, and an oxidant gas such as oxygen in air. In such polymer electrolyte fuel cells, catalyst layers composed mainly of powdered carbon with a platinum metal catalyst carried thereon are formed on both faces of a polymer electrolyte membrane which selectively transports hydrogen ions. On the outer face of each catalyst layer is formed a diffusion layer having permeability of the fuel and oxidant gases and electroconductivity. The combination of the polymer electrolyte membrane, the diffusion layers and the catalyst layers constitutes an electrode.

Gas sealants such as gaskets are arranged on the periphery of the electrodes such that gaskets sandwich the polymer electrolyte membrane in order to prevent the fuel and oxidant gases to be supplied thereto from leaking outside and from mixing with each other. The gas sealants are combined with the electrodes and the polymer electrolyte membrane to form one unit. The combination of the polymer electrolyte membrane and electrodes is called an “MEA” (membrane electrode assembly). On the outer faces of the MEA are arranged gas sealants and electroconductive separators for mechanically affixing the MEA and for electrically interconnecting adjacent MEAs with each other in series. The separator has gas channels for supplying the fuel and oxidant gases to the electrodes and for removing a generated gas and surplus gas on the portion thereof in contact with the MEA. The gas channels may be provided independently of the separator, but usually grooves are formed on the surface of the separator which serve as gas channels.

In order to supply the fuel and oxidant gases to the grooves, apertures are formed in the separator having gas channels formed thereon, and the gas channels are connected to the apertures from which the fuel and oxidant gases are directly supplied, respectively. The aperture for supplying the fuel or oxidant gas to each gas channel is called a “manifold aperture”.

The polymer electrolyte fuel cell generates heat during its operation so that it is necessary to cool the cell, such as by using cooling water to maintain the cell in the proper cell temperature range. Cooling units for flowing cooling water are usually provided every 1 to 3 unit cells between separators. Typically, a cooling water channel is formed on the back of the separator to serve as a cooling unit. In this case, the separator is required to have manifold apertures for conveying cooling water to the cooling water channels.

A stack formed by stacking 10 to 200 unit cells, each unit cell comprising the MEA, the separators and the cooling units, is typically sandwiched by current collector plates, insulating plates and end plates in this order, which is then fixed by inserting bolts therethrough to give a polymer electrolyte fuel cell.

The end plate has inlets respectively corresponding to the manifold apertures for the fuel gas, for the oxidant gas and for cooling water formed therein, through which the fuel gas, the oxidant gas and cooling water are supplied and removed.

Conventional polymer electrolyte fuel cells as described above, however, have the problem of cross leak. In particular, the fuel gas leaks to the oxidant-gas-side electrode (oxidant electrode), or the oxidant gas leaks to the fuel-gas-side electrode (fuel electrode) due to the occurrence of pinholes resulting from the initial failure, deterioration, etc. of a polymer electrolyte membrane as well as defects in the gasket, etc. The leaking fuel gas can directly react with the oxidant gas on the catalyst of the oxidant-gas-side electrode. If such a condition is maintained for a long period of time, pinholes are enlarged by the local generation of heat resulting from the reaction. In addition, combustion of the fuel gas is highly exothermic and, in extreme conditions, leads to the possibility of severely damaging the fuel cell system.

In an electrode of the above-described polymer electrolyte fuel cell, a thin polymer electrolyte membrane is sandwiched by catalyst layers and diffusion layers. Because of this structure, carbon fibers may be embedded in the polymer electrolyte membrane at a location where local pressure is applied, thereby creating the possibility of causing a micro short-circuit. In the location where a micro short-circuit occurs, a minute amount of current flows. Although it does not harm regular electricity generation performance, the short-circuit generates heat so that long-term use could develop pinholes, creating the possibility of the aforesaid problems.

To address some of the above problems, Japanese Laid-Open Patent Publication No. 2000-58095 discloses a method for detecting a deteriorated defective unit cell, by measuring, for example, the open circuit potential for each cell. U.S. Pat. No. 6,096,449 to Fuglevand et al. discloses a monitoring method for a fuel cell which includes a controller to sense the operational performance of one or more cells arranged in series and to shunt one or more of the cells upon the determination of a minimum threshold performance condition including current or voltage outputs. U.S. Patent Application Publication No. 2003-0039869 to Murakami discloses a method for detecting an abnormal cell in a fuel cell stack which includes measuring the voltage of a fuel cell after a predetermined time interval from the stoppage of the fuel cell.

Although the foregoing references address some aspect of deteriorating unit cells, a continuing need exists for detecting defective cells in a fuel cell stack, particularly for a hydrogen fuel cell, and to facilitate the safe operation thereof.

### BRIEF SUMMARY OF THE INVENTION

In view of the aforesaid problems, an object of the present invention is to address the safe operation of a polymer electrolyte fuel cell by providing a method for readily and accurately detecting a cross leak or a micro short-circuit caused by initial imperfections and/or the deterioration of the cell over its operation.

In one embodiment of the present invention, a method is provided for operating a fuel cell comprising, for example, a plurality of unit cells, each of which comprises a polymer electrolyte membrane, a pair of electrodes sandwiching the polymer electrolyte membrane, and electroconductive separators on either electrode. The cell stack generates electricity with the supply of a fuel gas to one of the electrodes and an oxidant gas to the other of the electrodes. The method comprises the steps of: determining an electric output of a single unit cell or a group of unit cells after the stoppage of the supply of fuel gas and oxidant gas, and comparing the electric output to a predetermined value, e.g., determining whether the single unit cell or group of cells has an electric output above or below a predetermined value or values. If the electric output falls below a certain predetermined valve, the cell or group of cells are determined to be defective.

The operating method preferably involves supplying a gas other than fuel or oxidant, e.g., an inert gas or a raw material gas containing methane gas or propane gas, to at least one of the pair of electrodes after the stoppage of the supply of the fuel gas and/or the oxidant gas, and then comparing an electric output of the single unit cell or group of cells during or after the supply of the other gas to a predetermined value. The electrical output which is measured can be from an individual cell in the cell stack or a group of cells in the cell stack and can be current, voltage, rate of voltage decrease, etc. or an average thereof such as average voltage over the predetermined length of time, etc. The predetermined value is preferably a voltage value, or average thereof of one or more normal cells and preferably at such a threshold value in which a metal catalyst of an electrode to be supplied with the fuel gas would begin to decompose, e.g., starts to melt.

In a preferred embodiment, an electric output change per time of the cell or cells can be checked for determining which of the cell or cells of the stack are defective.

In another aspect of the present invention, a hydrogen fueled cell is monitored for deterioration or prior to use. Such a system includes a stack of unit cells, e.g., a plurality of unit cells, wherein each of the unit cells comprise a polymer electrolyte membrane, a pair of electrodes sandwiching the polymer electrolyte membrane, and electroconductive separators. The stack generates electricity with the supply of a fuel gas containing hydrogen to one of the electrodes and an oxidant gas containing oxygen to the other of the electrodes, wherein the fuel cell further comprises a control unit for determining which of the single unit cell or a group of unit cells are defective when an electric output determined for the single unit cell or group of cells after stoppage of the supply of the fuel gas and/or the oxidant gas is not greater than a predetermined value.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1 is a diagram illustrating the structure of a polymer electrolyte fuel cell produced in an example of the present invention.

FIG. 2 is a top plan view illustrating the structure of a separator used in an example of the present invention.

FIG. 3 is a graph indicating the voltage behavior of a polymer electrolyte fuel cell of EXAMPLE 1 of the present invention.

FIG. 4 is a graph indicating the behavior of the voltage difference between normal unit cells and a unit cell developing pinholes in a polymer electrolyte fuel cell of EXAMPLE 1 of the present invention.

FIG. 5 is a graph indicating the voltage behavior of a polymer electrolyte fuel cell of EXAMPLE 2 of the present invention.

FIG. 6 is a graph indicating the behavior of the voltage difference between normal unit cells and a unit cell developing pinholes in a polymer electrolyte fuel cell of EXAMPLE 2 of the present invention.

FIG. 7 is a graph indicating the voltage behaviors of normal unit cells and a unit cell developing pinholes in a polymer electrolyte fuel cell of the present invention.

FIG. 8 is a graph indicating the voltage behaviors of normal unit cells and a unit cell developing pinholes in a polymer electrolyte fuel cell of the present invention.

FIG. 9 is a graph indicating the voltage behaviors of normal unit cells and a unit cell developing pinholes in a polymer electrolyte fuel cell of the present invention.

FIG. 10 is a graph indicating the voltage behaviors of normal unit cells and a unit cell developing pinholes in a polymer electrolyte fuel cell of the present invention.

FIG. 11 is a graph indicating the voltage behaviors of normal unit cells and a unit cell developing pinholes in a polymer electrolyte fuel cell of the present invention.

FIG. 12 is a graph indicating the voltage behaviors of normal unit cells and a unit cell developing pinholes in a polymer electrolyte fuel cell of the present invention.

### DETAILED DESCRIPTION OF THE INVENTION

The present invention stems from the observation and discovery that a deteriorating or defective unit cell or group of cells of a fuel cell stack experience a relatively sharp voltage drop upon cessation of fuel and/or oxidant to the fuel cell in comparison to a normally operating cell. The drop in voltage can be attributed to short-circuits and leaking of gas through the membrane of a unit cell that result from initial imperfections or develop over the life of the cell. These defects result in a lower efficiency for the cell stack and under extreme conditions may potentially cause significant damage to the fuel cell system. It was further observed and discovered that by introducing an inert gas or a raw material gas (i.e., a gas containing a component other than the gasses principally used to run the fuel cells) that the electric output between defective or deteriorating cells to normal cells is more distinct. Based on the foregoing, the present invention applies some of these principles to practice a method which can accurately and quickly detect the occurrence of a cross leak or a micro short-circuit.

In one embodiment of the present invention, a polymer electrolyte fuel cell comprising a plurality of unit cells is provided. Each of the unit cells comprise a polymer electrolyte membrane, a pair of electrodes sandwiching the polymer electrolyte membrane, and electroconductive separators contacting each electrode. The cell stack generates electricity with the supply of a fuel gas, such as hydrogen, to one of the electrodes and an oxidant gas, such as oxygen, to the other of the electrodes. The method is characterized by checking an electric output of the single unit cell or the group of unit cells after the stoppage of the supply of the fuel and oxidant gases so as to detect a defective unit cell or a defective group of unit cells in the fuel cell stack.

The electric output can be determined by measuring or monitoring the voltage of the single unit cell or the group of unit cells, the current thereof, or the change in the voltage or the current, for detecting a defective single unit cell or a defective group of unit cells in a fuel cell comprising a stack of unit cells. Therefore, the unit cell may have any structure. Likewise, there is no limitation on the number of the unit cells to be contained in the group of unit cells. In other words, the group of unit cells may have any number of unit cells.

In a preferred embodiment, a non-fuel and non-oxidant, e.g., an inert gas or the like, is supplied instead of the fuel or oxidant gas, after the stoppage of the supply of the fuel gas, during which the electric output or the like of the unit cell(s) is checked and then a defective unit cell(s) is detected. This is based on the fact that a unit cell(s) having a cross leak or a micro short-circuit consumes fuel and oxidant faster than normal unit cells. It is believed that the substitution of essentially non-reactant gases for the fuel and/or oxidant enhances this effect. Thereby, a minute leak or micro short-circuit that would otherwise be unobservable during normal operation can be detected.

Any non-reactant gas can be used instead of the fuel or oxidant gas provided that it does not substantially cause an electro-chemical reaction within the fuel cell. Examples of such gases include inert gases such as nitrogen gas, argon gas, helium gas, etc. Nitrogen is a preferred gas because it is relatively easily obtainable. Any amount of the non-reactant gas can be supplied to the fuel cell. The non-reactant gas can be supplied to either or both of the fuel side electrode or oxidant side electrode. The amount of such gas to be supplied will depend on various factors such as the gas volume of the fuel cell, etc. Preferably, the amount of the such gas to be supplied is in the range of about 5 to 30 liter/min. Preferably, the flow rate is adjusted such that a pressure loss becomes constant in order to limit the pressure applied to the MEAs during operation.

Further, it is preferred to detect a defective unit cell(s) in the fuel cell by checking whether the voltage value of the unit cell(s) is not greater than a predetermined voltage value. In other words, it is effective to detect a defective unit cell(s) in the fuel cell by checking whether the voltage value of the unit cell(s) measured after a previously-determined period of time (predetermined time) after the stoppage of the supply of the fuel and oxidant gases or after the start or after the end of the supply of the inert gas or raw gas to determine whether the output value is above or below a previously-determined threshold value (predetermined value). This is based on the fact that the voltage of a unit cell(s) with a cross leak or a micro short-circuit drops rapidly. The difference between normal unit cells and a unit cell(s) with a cross leak or a micro short-circuit observed at a specific time period can be sharp. The time period and threshold value can be determined beforehand by testing normal cells under a variety of operating conditions and testing defective cells under the same operating conditions to optimize a preferred predetermined value and time subsequent to stopping oxidant or fuel gas to the cell and/or introducing another gas to the cell.

The inert gas may be supplied to both the fuel and oxidant electrodes in the unit cells constituting a fuel cell. Alternatively, it may be supplied to either the fuel or oxidant electrode. In a practical system, the inert gas is preferably supplied only to the fuel electrode from a safety standpoint because the fuel electrode is purged with an inert gas every time the operation of a fuel cell is stopped in some system operations.

To measure the voltage, there can be used a multichannel data logger and a multichannel AD converter board. An example of a multichannel data logger is Agilent 34970 A manufactured by Agilent Technologies Corp. An example of a multichannel AD converter board is NA98-0164 manufactured by NATEC Corp. A voltage value measured is entered into a control computer (control unit) for example, which is then compared to the threshold value having previously been determined and stored in the computer.

Embodiments of the present invention is described in further detail by way of the following examples with reference to the accompanying drawings, but it is to be understood that the present invention is not limited to them.

### EXAMPLE 1

First of all, a first catalyst body (50 wt % of platinum) serving as the oxidant-electrode-side catalyst was prepared by allowing Ketjen Black EC (conductive carbon particles having a mean primary particle size of 30 nm and being manufactured by AKZO Chemie Company of the Netherlands) to carry platinum particles with a mean particle size of 30 Å. A second catalyst body (25 wt % of platinum and 25 wt % of ruthenium) serving as the fuel-electrode-side catalyst was prepared by allowing Ketjen Black EC to carry platinum particles and ruthenium particles with a mean particle size of 30 Å.

A dispersion obtained by dispersing the first catalyst body in isopropanol was mixed with a dispersion (Flemion FSS-1 manufactured by Asashi Glass Col., Ltd.) obtained by dispersing powdered perfluorocarbon sulfonic acid in ethyl alcohol to give a first paste. The obtained first paste was applied on one side of a carbon non-woven fabric with a thickness of 250 μm by a screen-printing technique to form a catalyst layer, and an electrode (oxidant-electrode) was produced. The amounts of the platinum and the perfluorocarbon sulfonic acid contained in the catalyst layer of the produced electrode were adjusted to be 0.5 mg/cm² and 1.2 mg/cm², respectively.

Likewise, a dispersion obtained by dispersing the second catalyst body in isopropanol was mixed with a dispersion obtained by dispersing powdered perfluorocarbon sulfonic acid in ethyl alcohol to give a second paste. The obtained second paste was applied on one side of a carbon non-woven fabric (TGP-H-090 manufactured by Toray Ind. Inc.) with a thickness of 250 μm by a screen-printing technique to form a catalyst layer, and an electrode (fuel-electrode) was produced. Similar to the above, the amounts of the platinum and the perfluorocarbon sulfonic acid contained in the catalyst layer of the produced electrode were adjusted to be 0.5 mg/cm² and 1.2 mg/cm², respectively.

Then, a proton-conductive polymer electrolyte membrane with a dimension one size larger than the above-obtained fuel and oxidant electrodes was interposed between the fuel and oxidant electrodes produced above such that the fuel and oxidant electrodes were positioned at the center of the proton-conductive polymer electrolyte membrane, the whole of which was then hot-pressed so that the catalyst layer and the polymer electrolyte membrane were thoroughly attached. The proton-conductive polymer electrolyte membrane used in this example was a membrane obtained by forming perfluorocarbon sulfonic acid polymer into a thin film (Nafion 112, manufactured by E. I. Du Pont de Nemours & Co. Inc. of the United States). The peripheral portion of the polymer electrolyte membrane which is not covered with the fuel or oxidant electrode was sandwiched between gaskets (such as those composed of fluorinated rubber available from NOK Corp.) punched into the same shape as the separator described below, which was then hot-pressed to give an MEA (membrane electrode assembly). Hot pressing was performed at 120° C. with 2.5 MPa pressure for about 10 min.

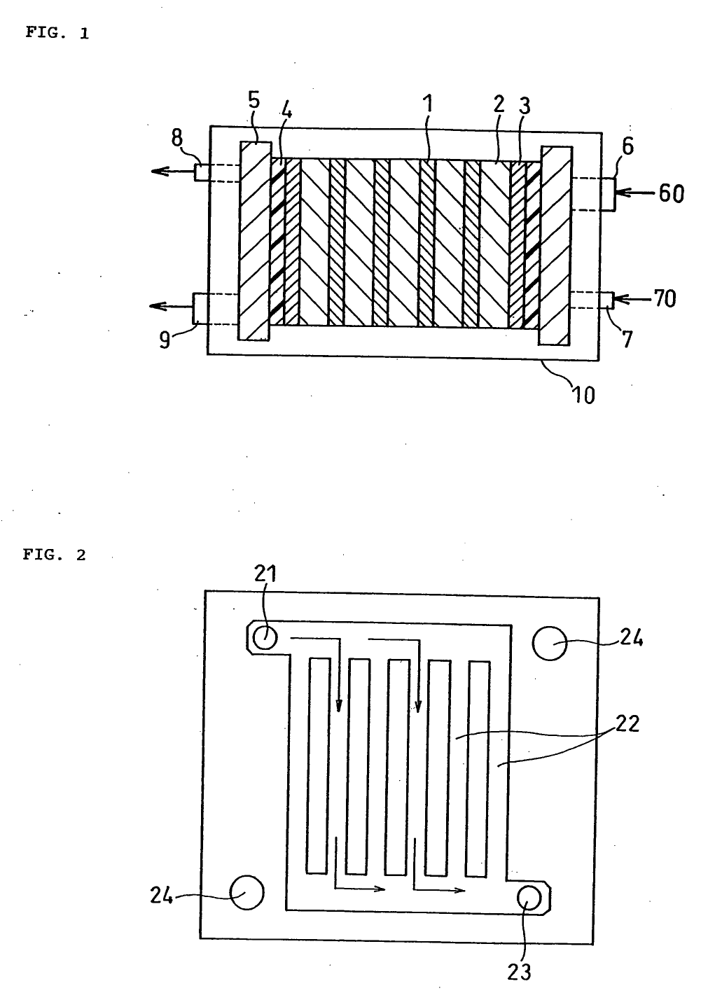

The structure of the polymer electrolyte fuel cell produced in this example is shown in FIG. 1. As seen in FIG. 1, a polymer electrolyte fuel cell 10 was constructed by sandwiching a stack cell formed by alternately stacking MEA 1 and separator 2 by current collector plates 3, insulating plates 4 and end plates 5 in this order, which was then clamped with a predetermined pressure. A pressure of about 1000 kgf was applied onto a total area of 430 cm². Separators 2 were composed of conductive carbon (available from Tokai Carbon Co., Ltd.), collector plates were gold coated copper plates, insulating plates 4 were composed of polyphenylene sulfide and end plates 5 were made of steel JIS-Code SUS316. In one of the end plates 5 were formed an oxidant gas manifold aperture inlet 6 for supplying an oxidant gas 60 from an external gas supplying device (not shown in the figure) and a fuel gas manifold aperture inlet 7 for supplying a fuel gas from an external supply. In the other of the end plates were formed a fuel gas manifold aperture outlet 8 for removing the fuel gas to an oxidant gas manifold aperture outlet 9 for removing the oxidant gas 60. These outlets also remove exhaust gases. These inlets and outlets had a tube-like shape.

FIG. 2 shows a top plan view of the separator 2 used in this example. Separator 2 was provided with an inlet manifold aperture 21 for introducing a gas supplied from the oxidant gas manifold aperture inlet 6 or the fuel gas manifold aperture inlet 7 shown in FIG. 1, a gas channel 22 being connected to the inlet manifold aperture 21, and an outlet manifold aperture 23 for removing the gas having passed through gas channel 22. Manifold apertures 24 for cooling water was also formed thereon.

The fuel cell of this example had 50 such unit cells stacked in series.

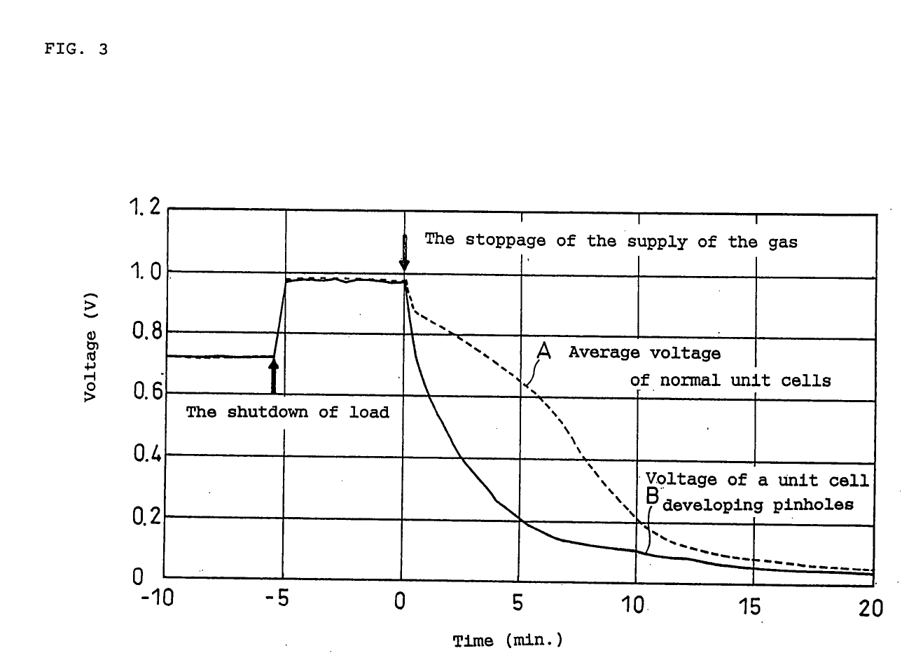

Next, the performance of the polymer electrolyte fuel cell of this example and its voltage behavior after the stoppage of the supply of the fuel and oxidant gases were observed (measured). The results are shown in FIG. 3. In the observation, a simulated reformed gas (80% by volume of hydrogen, 20% by volume of carbon dioxide and 50 ppm of carbon monoxide) was used as the fuel gas, and air was used as the oxidant gas. The observation was performed under a hydrogen utilization rate of 80 %, an oxygen utilization rate of 50%, a bubble temperature for humidifying hydrogen of 75° C., a bubble temperature for humidifying air of 50° C., a battery temperature of 75° C., and a current density of 0.3 A/cm². The utilization ratio and the power generation of the fuel cell depends on the chemical reaction of: H₂+½ O₂ to H₂O. If all of the supplied hydrogen is reacted, the utilization ratio is 100%. In general, however, about 30% of the supplied hydrogen in not reacted but discharged due to various reasons.

The fuel cell was first operated under the above conditions. Then, the load was shut down to stop the supply of the fuel and oxidant gases, and the manifold aperture inlets and outlets for fuel and oxidant gases were closed. The voltage decrease of the fuel cell was plotted in the graph of FIG. 3. FIG. 3 shows the average voltage of normal unit cells and the voltage of a unit cell developing a cross leak. After the load current was shut down, each of the unit cells showed an open-circuit voltage, but the voltage started to decrease gradually right after the supply of hydrogen was stopped and the inlets and outlets were closed, and fell to below about 0.1 V after about 20 minutes.

As is apparent from FIG. 3, a unit cell having pinholes had a faster decreasing rate than normal unit cells. This was attributed to a cross leak between the fuel and oxidant gases occurred at pinholes so that the consumption of the fuel gas remaining around the MEAs was accelerated. Similar result was obtained in the case of a unit cell developing a micro short-circuit. In this case also, it is considered that the consumption of residual hydrogen was accelerated due to very low currents.

Therefore, the occurrence of a cross leak or a micro short-circuit can be easily and accurately detected by checking electric output, e.g., the decreasing rate of the voltage, of unit cells after the stoppage of the supply of the fuel and oxidant gases. When a unit cell(s) had a voltage value of not greater than a predetermined value, which is measured after a given period of time after the stoppage of the supply of hydrogen, the unit cell(s) was determined as developing pinholes or a micro short-circuit.

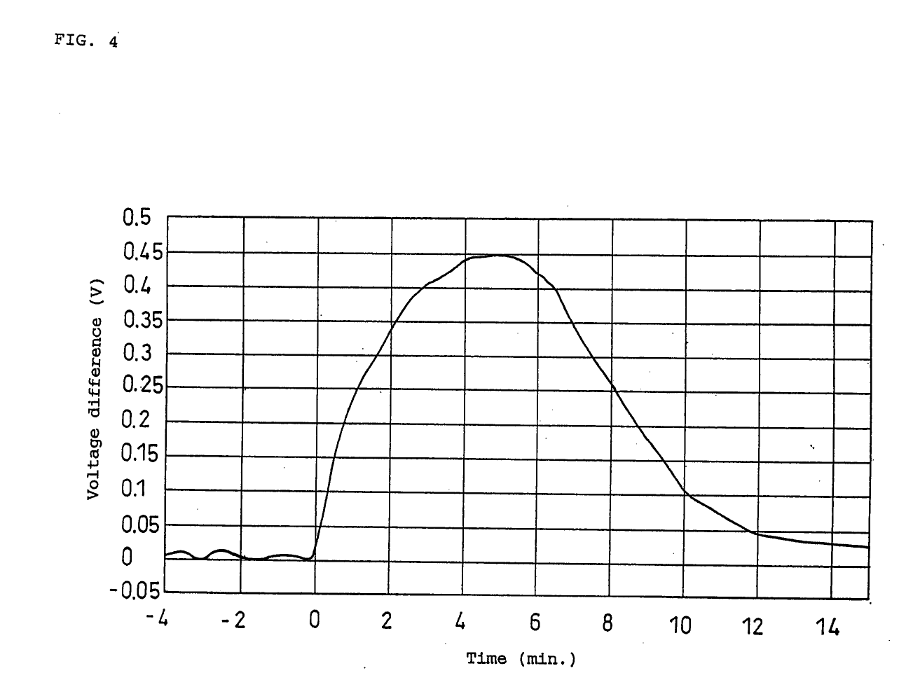

FIG. 4 shows a graph of the voltage difference between the average voltage of normal unit cells and the voltage of the unit cell developing pinholes versus time. In order to detect a unit cell developing pinholes with high precision, the judgment is preferably made based on the time period when the voltage difference between normal unit cells and the unit cell developing pinholes is most significant. As is apparent from FIG. 4, it is about after 5 minutes after the stoppage of the supply of the fuel gas that the greatest voltage difference was observed.

Accordingly, in this example, a voltage value of 0.4 V observed after 5 minutes after the stoppage of the supply of the fuel and oxidant gases was used as the threshold value of electric output (predetermined value). It can be seen from the voltage behaviors in FIGS. 3 and 4 that the predetermined time is preferably in the range of 2 to 7 minutes and the predetermined voltage value is preferably set to between 0.7 V and 0.2 V. This is because the difference between normal and abnormal voltages is likely to be clearly detected in these ranges.

This enables a practical cogeneration system to generate an alarm (visual or audible) upon detection of a unit cell developing pinholes as described above, and to inform the user that maintenance is required. In this example, the method was used in an actual operating fuel cell, but it is to be noted that this method is also applicable for use for shipping inspection immediately after the assembly of a fuel cell or at such preparation time period.

### EXAMPLE 2

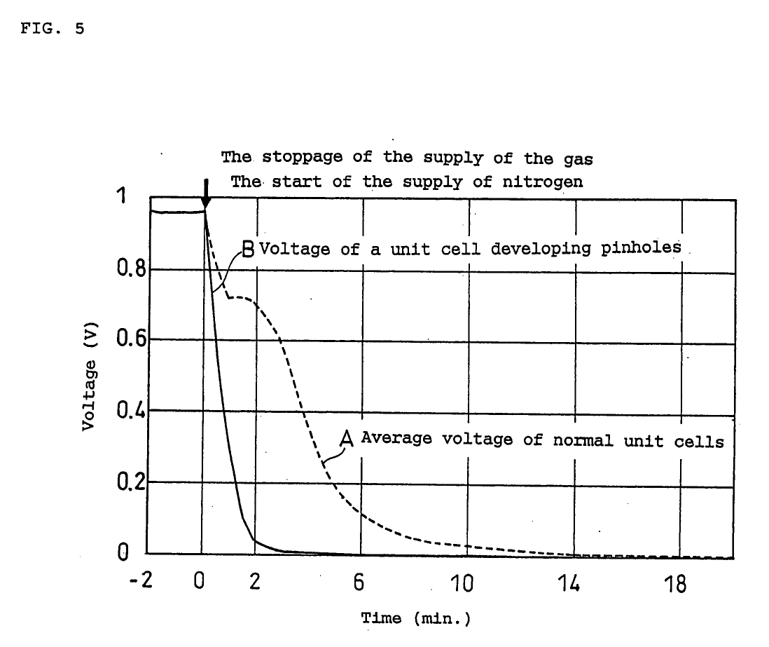

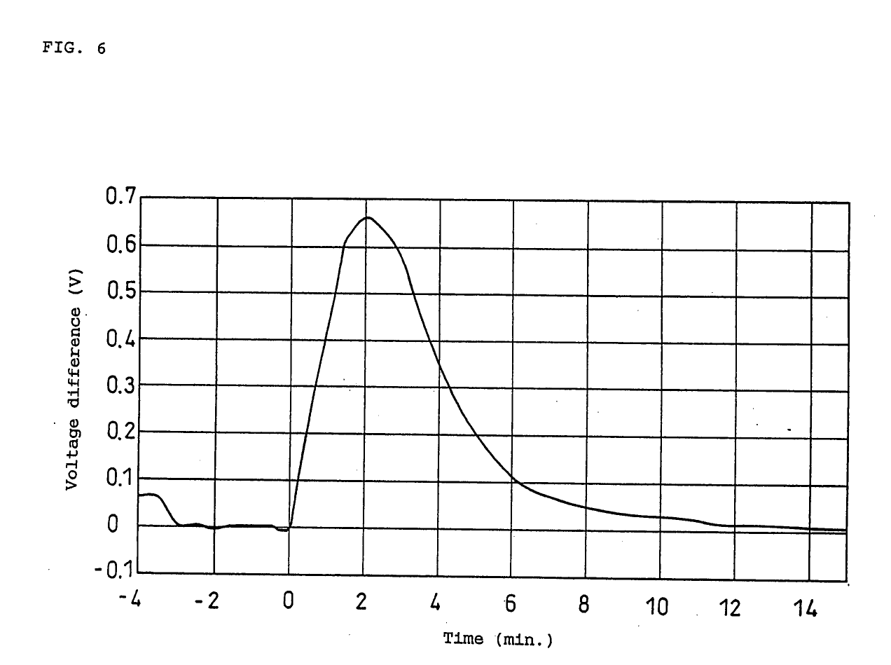

FIG. 5 shows the voltage behavior of the polymer electrolyte fuel cell of this example. This example employed a fuel cell analogous to the one used in EXAMPLE 1. In addition, nitrogen gas was fed into the fuel electrode as the inert gas after the stoppage of the supply of the fuel and oxidant gases to the fuel cell. Similar to EXAMPLE 1, the voltage behavior of a unit cell with a cross leak and the average voltage of normal unit cells were shown in FIG. 5.

Compared to the case where nitrogen gas was not fed, the voltages of both unit cells rapidly dropped to not greater than 0.1 V within 10 minutes. From this, it is apparent that hydrogen was forced to be removed by nitrogen gas and thereby the voltage reduction was accelerated. Accordingly, the use of nitrogen gas advances the detection time of a unit cell developing a cross leak or pinholes to about half the time expected when nitrogen gas was not fed.

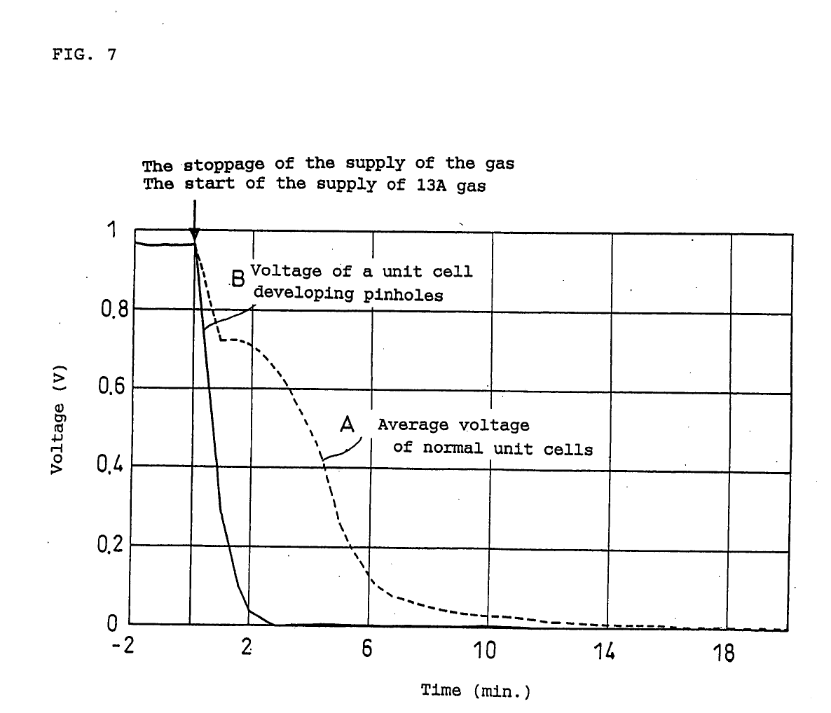

FIG. 6 shows a graph of the voltage difference between the average voltage of normal unit cells and the voltage of the unit cell developing pinholes versus time. As is clear from FIG. 6, the greatest voltage difference was observed about 2 minutes after the start of the supply of nitrogen gas. Accordingly, a voltage value of 0.4 V observed after 2 minutes after the start of the supply of nitrogen gas was used as the threshold value in this example. It can be seen from the voltage behaviors in FIGS. 5 and 6 that the predetermined time is preferably in the range of about 1 to 4 minutes and the threshold voltage value is preferably set to between about 0.6 V and 0.2 V. As is apparent from the above examples, the introduction of an inert gas, such as nitrogen, after stoppage of fuel and/or oxidant gases to a fuel cell advantageously enhances the detection efficiency by reducing detection times and increasing the electric output differences between defective and normal cells thereby enhancing the rate and accuracy of detecting defective cells within a stack.

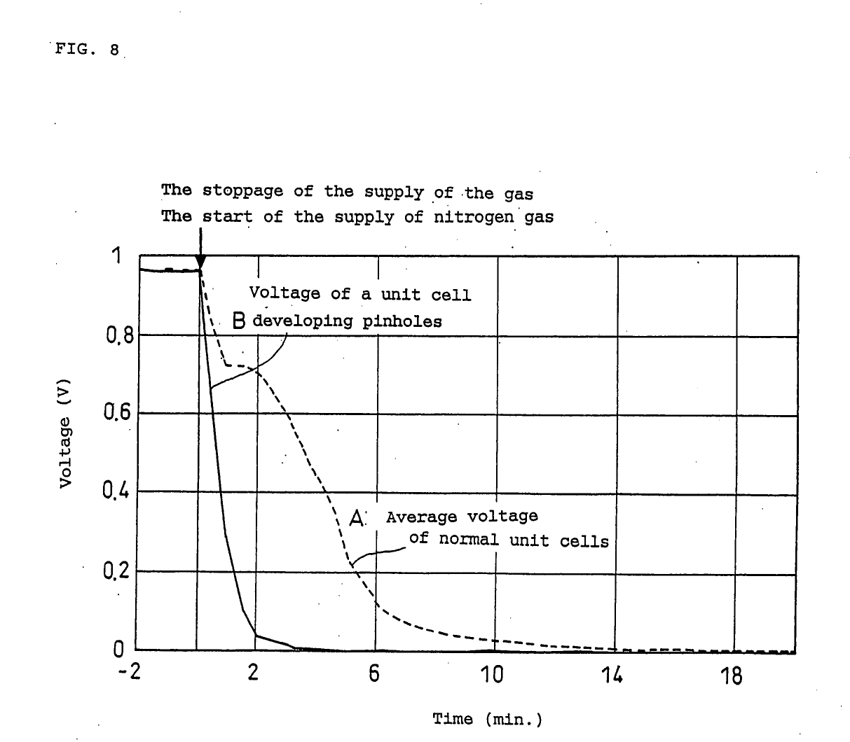

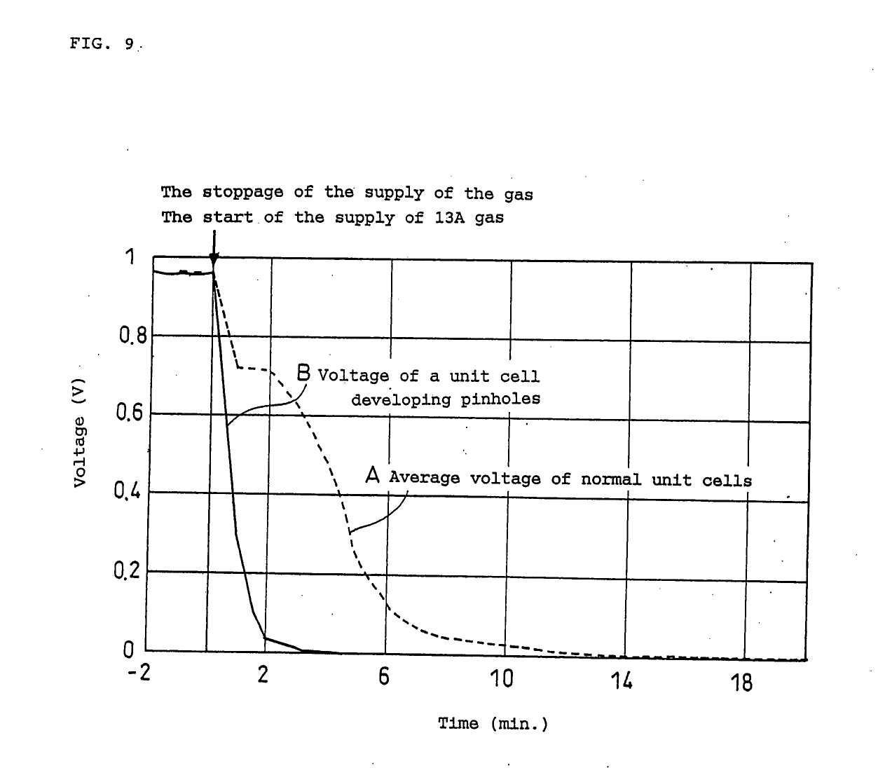

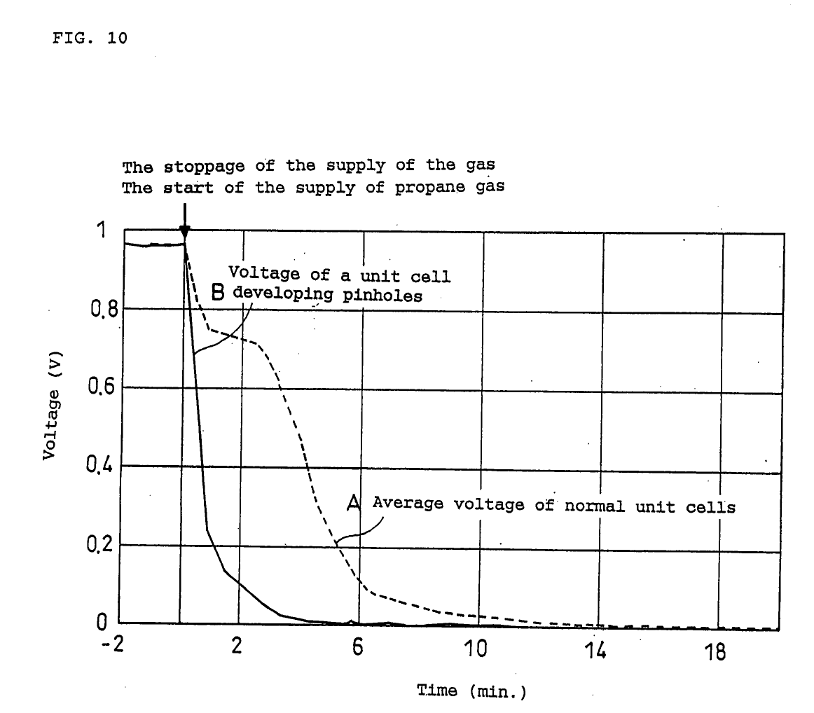

FIG. 7 shows the voltage behavior when city gas (13A) composed mainly of methane gas was fed into the fuel electrode after the stoppage of the supply of the fuel and oxidant gases. FIG. 8 shows the voltage behavior when nitrogen gas was fed into the oxidant electrode after the stoppage of the supply of the fuel and oxidant gases. FIG. 9 shows the voltage behavior when city gas was fed into the oxidant electrode after the stoppage of the supply of the fuel and oxidant gases.

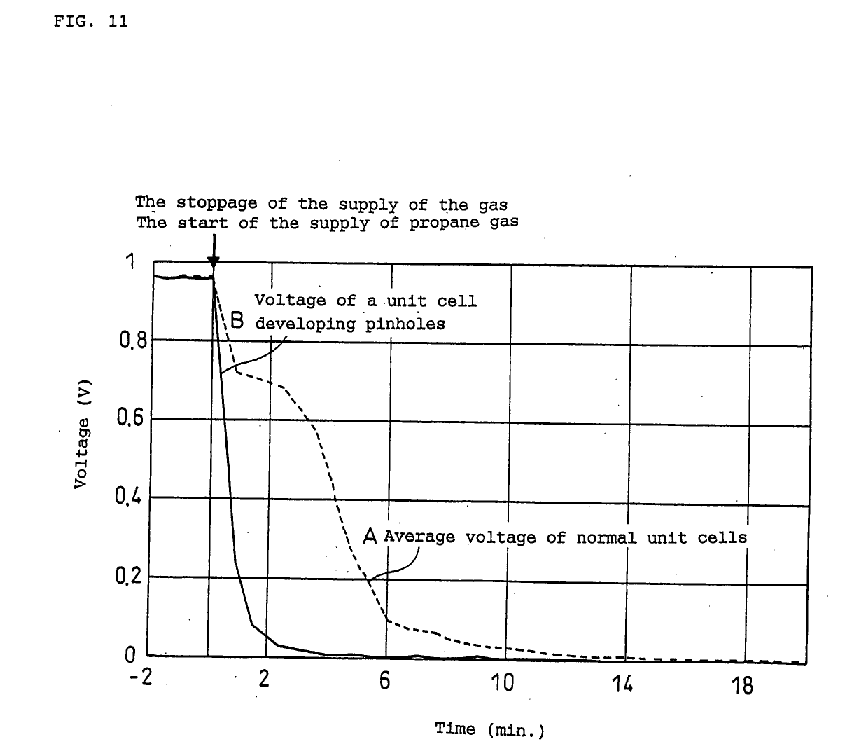

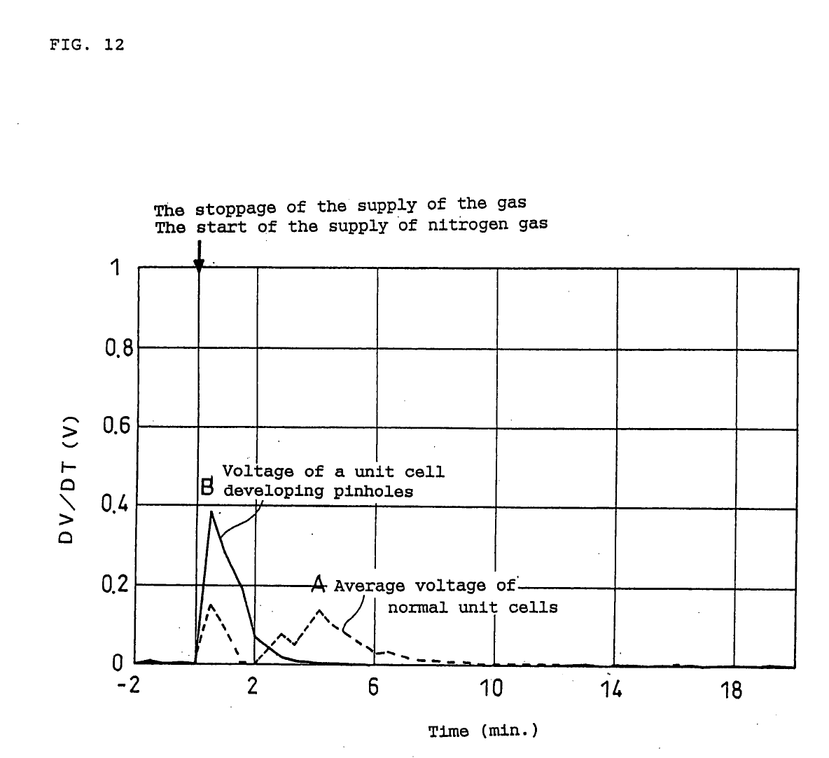

FIG. 10 shows the voltage behavior when propane gas was fed into the oxidant electrode after the stoppage of the supply of the fuel and oxidant gases. FIG. 11 shows the voltage behavior when propane gas was fed into the fuel electrode after the stoppage of the supply of the fuel and oxidant gases. The behaviors indicated in the above graphs were very much similar to that of FIG. 5 of EXAMPLE 2. This proves that, other than nitrogen gas, helium gas or argon gas can be used as the inert gas.

Similar results were also obtained in the case of a unit cell developing a micro short-circuit, which has made it clear that this method is also effective in detecting a unit cell developing a micro short-circuit.

### EXAMPLE 3

The voltage behavior of the polymer electrolyte fuel cell of this example is shown in FIG. 12. This example employed a fuel cell analogous to the one used in EXAMPLE 1, and nitrogen gas was fed into the fuel electrode as the inert gas after the stoppage of the supply of the fuel and oxidant gases. The voltage change (dV/dT) of unit cell under the above condition versus time was shown in FIG. 12. The voltage change was plotted every 30 seconds.

As is clear from FIG. 12, the voltage change of the defective unit cell was obviously larger that that of normal unit cells. This has proved that a unit cell developing pinholes or a micro short-circuit can be detected also by checking the voltage change per time.

### EXAMPLE 4

This example employed a fuel cell analogous to the one used in EXAMPLE 1, and nitrogen gas was fed into the fuel electrode as the inert gas after the stoppage of the supply of the fuel and oxidant gases, during which if a unit cell(s) having a voltage of not greater than a predetermined value was found, the unit cell(s) was identified as defective. The predetermined value was experimentally determined.

The voltage of a fuel cell usually means a difference between the absolute potential of the fuel electrode and that of the oxidant electrode. When no current is flowing, the potential of the fuel electrode is about 0 V and that of the oxidant electrode is about 1 V. The reason that the cell voltage drops after the stoppage of the supply of the fuel gas to the fuel cell or after the start of the supply of an inert gas or city gas to the fuel electrode is believed because the potential of the fuel electrode increases and approaches that of the oxidant electrode.

When the potential of the fuel electrode increases and reaches not less than about 0.5 V, for example, it is known that ruthenium, which is used as the metal catalyst in some fuel electrodes, starts to melt. Accordingly, when the potential of the fuel electrode increases and the cell voltage drops to less than 0.5 V, the catalyst is very likely to be degraded.

The above indicates that the threshold voltage value for determining whether the unit cell(s) is defective or not is preferably not less than 0.5 V when a ruthenium catalyst is used, in order to detect a defective unit cell developing pinholes or a micro short-circuit without causing any damage to normal unit cells.

According to the present invention, when a defective unit cell(s) developing a cross leak or a micro short-circuit is present in a fuel cell comprising a stack of unit cells, it is possible to easily, quickly and accurately detect the occurrence of a cross leak or a micro short-circuit by making use of the fact that the voltage of a defective unit cell(s) drops comparatively rapidly after the stoppage of the supply of the fuel gas compared to normal unit cells. The rate of decrease and the difference in electric output can be enhanced by the introduction or flushing with non fuel gases into the cell. Thereby, a cogeneration system can generate an alarm to inform the user that maintenance is required, leading to a great improvement in safety during actual operation. The method in accordance with the present invention is also applicable for use for shipping inspection of a product fuel cell.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A method for operating a polymer electrolyte fuel cell comprising a plurality of unit cells, each of said unit cells comprising a polymer electrolyte membrane, a pair of electrodes sandwiching said polymer electrolyte membrane, and electroconductive separators, which generates electricity with the supply of a fuel gas to one of said electrodes and an oxidant gas to the other of said electrodes, said method comprising the steps of:
determining an electric output of said single unit cell or a group of said unit cells after the stoppage of the supply of either said fuel gas or said oxidant gas and the introduction of another gas to at least one of said pair of electrodes; and
comparing said electric output to a predetermined value.

2. The method for operating a polymer electrolyte fuel cell in accordance with claim 1, comprising the steps of:
supplying an inert gas or a raw material gas containing methane gas or propane gas to at least one of said pair of electrodes after the stoppage of the supply of said fuel gas or said oxidant gas as the other gas.

3. The method for operating a polymer electrolyte fuel cell in accordance with claim 1, wherein the electric output that is determined is an electric output change over time.

4. The method for operating a polymer electrolyte fuel cell in accordance with claim 1, wherein said predetermined value is an approximate voltage value at which a metal catalyst of one of said electrodes to be supplied with said fuel gas starts to melt.

5. The method for operating a polymer electrolyte fuel cell in accordance with claim 1, further comprising determining whether said electric output is less than the predetermined value.

6. The method for operating a polymer electrolyte fuel cell in accordance with claim 1, wherein said electric output is current, voltage, rate of voltage decrease, or an average thereof.

7. The method for operating a polymer electrolyte fuel cell in accordance with claim 1, wherein said electric output is determined after about 1 minute to about 4 minutes from the introduction of another gas to at least one of said pair of electrodes.

8. The method for operating a polymer electrolyte fuel cell in accordance with claim 1, wherein the other gas is supplied to the fuel cell electrode.

9. The method for operating a polymer electrolyte fuel cell in accordance with claim 1, wherein both said fuel gas or said oxidant gas are stopped prior to the introduction of the other gas.

10. The method for operating a polymer electrolyte fuel cell in accordance with claim 1, wherein the other gas is nitrogen and it is supplied to the fuel cell electrode.

11. A polymer electrolyte fuel cell comprising a plurality of unit cells, each of said unit cells comprising a polymer electrolyte membrane, a pair of electrodes sandwiching said polymer electrolyte membrane, and electroconductive separators on either of said electrodes, which generates electricity with the supply of a fuel gas to one of said electrodes and an oxidant gas to the other of said electrodes,
wherein said fuel cell further comprises a control unit for determining said single unit cell or a group of said unit cells as defective when an electric output thereof is not greater than a predetermined value after the stoppage of the supply of either said fuel gas or said oxidant gas and the introduction of another gas to at least one of said pair of electrodes.
